(19) United States
(12) Patent Application Publication
(10) Pub. No.: US 2010/0283721 A1
(43) Pub. Date: Nov. 11, 2010

(54) Photoelectric Display Panel and Electronic Device Using the Same

(75) Inventors: Wen-Chun Wang, Taichung City (TW); Chin-Chang Liu, Tanzih Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/774,801

(22) Filed: May 6, 2010

(30) Foreign Application Priority Data
May 6, 2009 (TW) 98115041

(51) Int. Cl. G09G 3/34

(52) U.S. Cl. 345/107

(57) ABSTRACT

A photoelectric display panel including a first substrate and a second substrate is provided. The first substrate being parallel to the second substrate has a pixel array including a plurality of display pixels. The second substrate includes a base plate and a black matrix located between the base plate and the first substrate. The black matrix has a first photoelectric transform block and a second photoelectric transform block. The first photoelectric transform block has a first transparent electrode, a first semiconductor layer and a first metal electrode that are laminated on the base plate. The second photoelectric transform block has a second transparent electrode, a second semiconductor layer and a second metal electrode that are laminated on the base plate. The second transparent electrode is electrically connected with the first metal electrode, so that the second photoelectric transform block and the first photoelectric transform block are connected in series.

This application claims the benefit of Taiwan application Serial No. 98115041, filed May 6, 2009, the subject matter of which is incorporated herein by reference.

### BACKGROUND OF THE INVENTION

1. Field of the Invention

The invention relates in general to a display panel, and more particularly to a photoelectric display panel.

2. Description of the Related Art

Most portable electronic devices, such as mobile phone, personal digital assistant (PDA), PDA mobile phone, digital camera, game boy, translation machine, auto AV device, notebook computer, are powered by battery. The battery, having a limited capacity and a particular discharge time, must be replaced or charged when its capacity is used up.

Of the foregoing electronic devices, display panel and light source are the main power consuming elements. Particular, the liquid crystal display panel relies on the power a lot. If the power supply is not sufficient, there will be a problem for the user. Therefore, how to increase the efficiency of the battery of the electronic device has become a focus to the manufacturers of electronic devices.

### SUMMARY OF THE INVENTION

The invention is directed to a photoelectric display panel and an electronic device using the same. When radiated by the light, the display panel generates photoelectric transform effect and self-powered.

According to a first aspect of the present invention, a photoelectric display panel including a first substrate and a second substrate is provided. The first substrate has a pixel array including a plurality of display pixels. The second substrate being parallel to the first substrate includes a base plate and a black matrix, wherein, the black matrix is located between the base plate and the first substrate. The black matrix includes a first photoelectric transform block and a second photoelectric transform block. The first photoelectric transform block has a first transparent electrode, a first semiconductor layer and a first metal electrode that are sequentially laminated on the base plate. The second photoelectric transform block has a second transparent electrode, a second semiconductor layer and a second metal electrode that are sequentially laminated on the base plate. The second transparent electrode is electrically connected with the first metal electrode, so that the second photoelectric transform block and the first photoelectric transform block are connected in series.

According to a second aspect of the present invention, an electronic device including a light source and a display panel is provided. The display panel, disposed on one side of the light source, includes a first substrate and a second substrate. The first substrate has a pixel array including a plurality of display pixels, each having at least one pixel switch. The second substrate, being parallel to the first substrate, includes a base plate, a black matrix and a color filtering structure, wherein, the black matrix and the color filtering structure are sequentially located on the base plate and located between the base plate and the first substrate. The color filtering structure includes a plurality of light filtering layers corresponding to the display pixels. The black matrix includes a first photoelectric transform block and a second photoelectric transform block. The first photoelectric transform block has a first transparent electrode, a first semiconductor layer and a first metal electrode that are sequentially laminated on the base plate. The second photoelectric transform block has a second transparent electrode, a second semiconductor layer and a second metal electrode that are sequentially laminated on the base plate. The second transparent electrode is electrically connected with the first metal electrode, so that the second photoelectric transform block and the first photoelectric transform block are connected in series.

The invention will become apparent from the following detailed description of the preferred but non-limiting embodiments. The following description is made with reference to the accompanying drawings.

### BRIEF DESCRIPTION OF THE DRAWINGS

FIG. 1 shows an electronic device according to a preferred embodiment of the invention;

FIG. 2 shows a top view of a display panel of the electronic device of FIG. 1;

FIGS. 3A, 3B and 3C respectively show cross-sectional views of the second substrate of FIG. 2 viewed along the cross-sectional lines A-A′, B-B′, C-C′;

FIG. 4 shows the thickness of a metal electrode of a black matrix being reduced;

FIGS. 5A, 5B and 5C respectively show cross-sectional views of the second substrate of FIG. 2 viewed along the cross-sectional lines A-A′, B-B′, C-C′ with openings on the metal electrode;

FIGS. 6A, 6B and 6C respectively show cross-sectional views of the second substrate of FIG. 2 viewed along the cross-sectional lines A-A′, B-B′, C-C′ with an insulation layer; and

FIG. 7 shows a self-illuminant display element.

### DETAILED DESCRIPTION OF THE INVENTION

The present embodiment of the invention discloses a photoelectric display panel and an electronic device using the same. The substrate structure of the display panel includes a base plate and a black matrix. The black matrix is composed of a plurality of photoelectric transform blocks which are electrically connected together. Apart from blocking the light, the black matrix further absorbs and transforms an external light source into new power, and further uses the power. The substrate structure with photoelectric effect and the display panel and the electronic device using the same are exemplified by a number of drawings and implementations below.

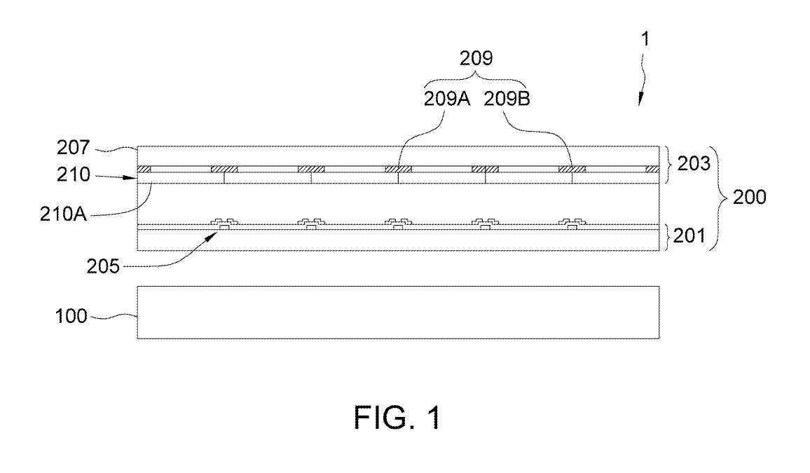

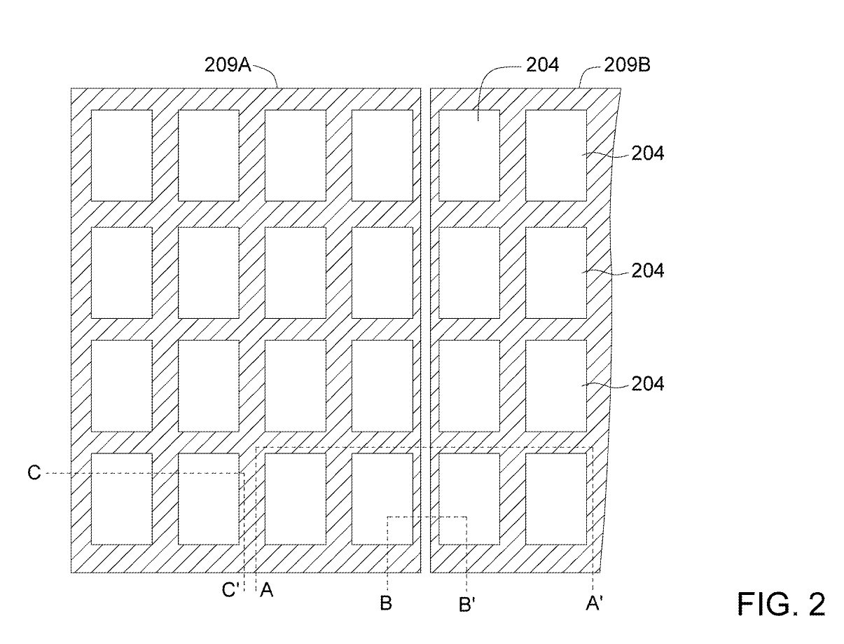

Refer to FIGS. 1 and 2. FIG. 1 shows an electronic device according to a preferred embodiment of the invention. FIG. 2 shows a top view of a display panel of the electronic device of FIG. 1. As indicated in FIG. 1, the electronic device 1 includes a light source 100 and a photoelectric display panel 200. The light source 100, such as a backlight module, is disposed on one side of the display panel 200 for providing light to the display panel 200. The display panel 200 includes a first substrate 201 and a second substrate 203. The first substrate 201 has a pixel array, which includes a plurality of display pixels 204 (referring to FIG. 2) each having at least one pixel switch 205. The second substrate 203, parallel to the first substrate 201, includes a base plate 207 and a black matrix 209, wherein, the black matrix 209 is located between the base plate 207 and the first substrate 201. The black matrix 209 includes a plurality of photoelectric transform blocks. The present embodiment of the invention is exemplified by a first photoelectric transform block 209A and a second photoelectric transform block 209B adjacent to each other. The first photoelectric transform blocks 209A and the second photoelectric transform block 209B respectively correspond to a plurality of display pixels 204 (referring to FIG. 2). Furthermore, the second substrate 203 further has a color filtering structure 210. The color filtering structure 210 is located between the base plate 207 and the first substrate 201, and the black matrix 209 and the color filtering structure 210 are sequentially located on the base plate 207. The color filtering structure 210 has a plurality of light filtering layers 210A each corresponding to a display pixel 204 (referring to FIG. 2).

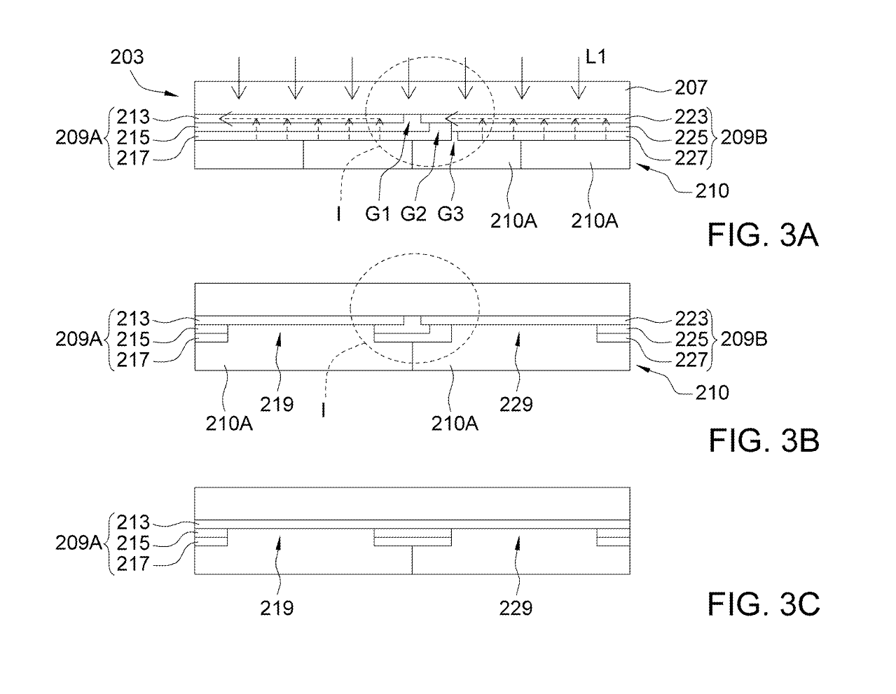

Referring to FIGS. 3A, 3B and 3C, cross-sectional views of the second substrate of FIG. 2 viewed along the cross-sectional lines A-A′, B-B′, C-C′ are respectively shown. As indicated in FIG. 3A, the first photoelectric transform block 209A includes a first transparent electrode 213, a first semiconductor layer 215 and a first metal electrode 217 sequentially disposed on a lower surface of the base plate 207. The first photoelectric transform block 209A further includes a plurality of first openings 219 (referring to FIG. 3B) penetrating the first semiconductor layer 215 and the first metal electrode 217, wherein each first opening 219 corresponds to a display pixel 204 (referring to FIG. 2), and the light filtering layer 210A fills up the first opening 219. The second photoelectric transform block 209B includes a second transparent electrode 223, a second semiconductor layer 225 and a second metal electrode 227, sequentially disposed on the lower surface of the base plate 207. The second photoelectric transform block 209B further includes a plurality of second openings 229 (referring to FIG. 3B) penetrating the second semiconductor layer 225 and the second metal electrode 227, wherein each second opening 229 corresponds to a display pixel 204 (referring to FIG. 2), and the light filtering layer 210A fills up the second opening 229. As indicated in the area I of FIG. 3A, the first metal electrode 217 is electrically connected with the second transparent electrode 223, so that the first and the second photoelectric transform blocks 209A and 209B are connected in series.

As indicated in the serial connection area I of two photoelectric transform blocks, there is a first gap G1 formed between the first transparent electrode 213 and the second transparent electrode 223, so that the first transparent electrode 213 and the second transparent electrode 223 are not connected. The first semiconductor layer 215 fills up the first gap G1 and partly extended on the second transparent electrode 223. Besides, there is a second gap G2 formed between the first semiconductor layer 215 and the second semiconductor layer 225, and the first metal electrode 217 fills up the second gap G2 for electrically connecting the second transparent electrode 223. The first metal electrode 217 and the second metal electrode 227 are separated by a third gap G3 lest the first metal electrode 217 and the second metal electrode 227 might be connected.

The first semiconductor layer 215 and the second semiconductor layer 225 both are a P-N joint structure, wherein, one single P-N joint structure includes a P-type semiconductor and an N-type semiconductor. The P-N joint structure can be amorphous Si, poly crystalline Si or micro-crystal Si and can be made from an organic semiconductor material or an inorganic semiconductor material. When the P-N joint structure is radiated by light, the P-type and N-type semiconductor will generate an electron-hole pair so that electrons flow in the semiconductor. A photo-battery structure is formed by inducing the current by the transparent electrode and the metal electrode that are disposed on the top and the bottom of the semiconductor layer. As indicated in FIG. 3A, the first and the second photoelectric transform blocks 209A and 209B respectively form an complete photo-battery, wherein the first and the second photoelectric transform blocks 209A and 209B are connected through the serial connection area I. When the second substrate 203 is radiated by an external light L1, the directions of the currents generated by the first and the second photoelectric transform blocks 209A and 209B are indicated by the arrows in dotted lines. The present embodiment of the invention is exemplified by the first and the second photoelectric transform block 209A, 209B only. However, the entire black matrix 209 of the second substrate 201 is composed by a plurality of photoelectric transform blocks connected in series, so that the voltage generated by the entire display panel 200 is increased through serial connection. Thus, the outputted voltage can be used as a power supply or other purposes.

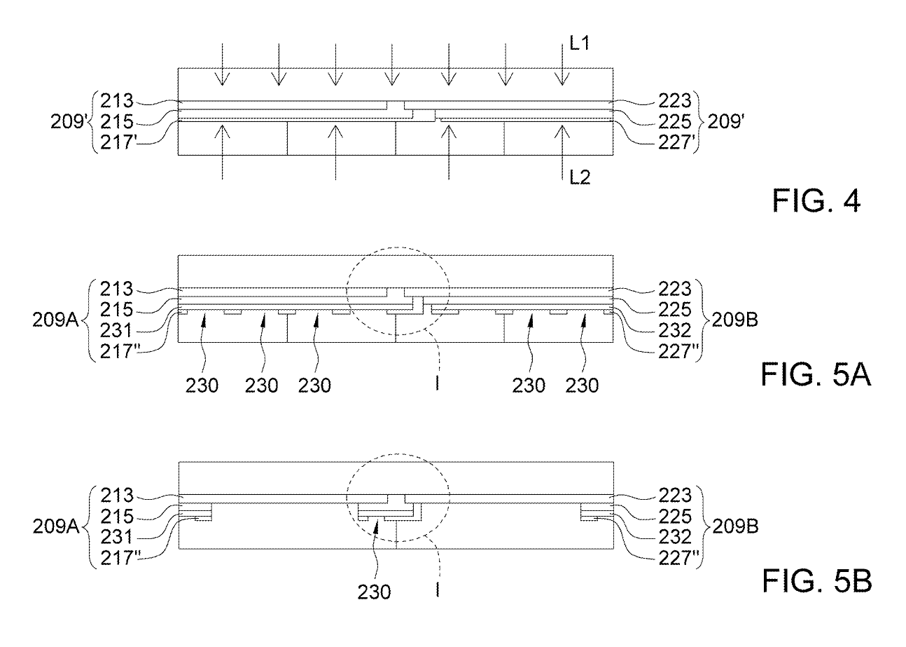

Referring to FIG. 4, the thickness of a metal electrode of a black matrix being reduced is shown. As indicated in FIG. 4, the first and the second metal electrodes 217′ and 227′ of the black matrix 209′ are thinner than the first and the second metal electrodes 217 and 227, so that the first and the second metal electrodes 217′ and 227′ are similar to transparent metal films with transflectiveness property. Thus, the black matrix 209′ can generate power by the direct radiation of the external light L1, the reflected light from the first substrate 201 (referring to FIG. 1) and a backlight light L2 of the light source 100 (referring to FIG. 1).

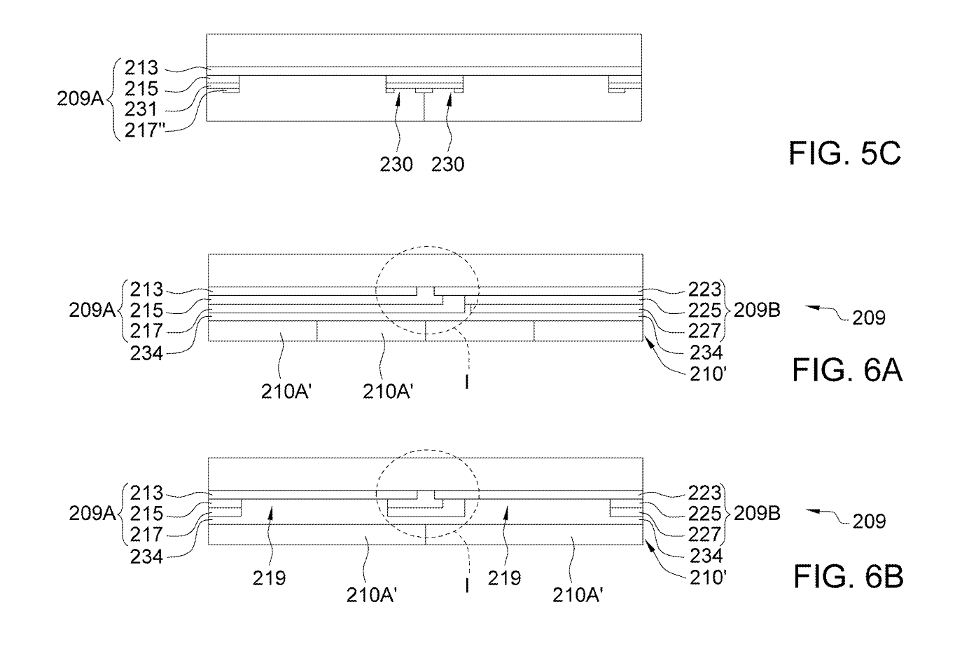

Referring to FIGS. 5A, 5B and 5C, cross-sectional views of second substrate of FIG. 2 viewed along the cross-sectional lines A-A′, B-B′, C-C′ with openings on the metal electrode are respectively shown. As indicated in FIG. 5A, the first metal electrode 217″ and the second metal electrode 227″ respectively have a plurality of openings 230. Preferably, the first photoelectric transform block 209A further has a third transparent electrode 231 disposed between the first semiconductor layer 215 and the first metal electrode 217″, and the second photoelectric transform block 209B further has a fourth transparent electrode 232 disposed between the second semiconductor layer 225 and the second metal electrode 227″. The first metal electrode 217″ and the second metal electrode 227″ have openings 230, which cannot be used for forming a photo-battery properly. Thus, the third transparent electrode 231 and the fourth transparent electrode 232 enable the first and the second photoelectric transform blocks 209A and 209B to generate photoelectric effect.

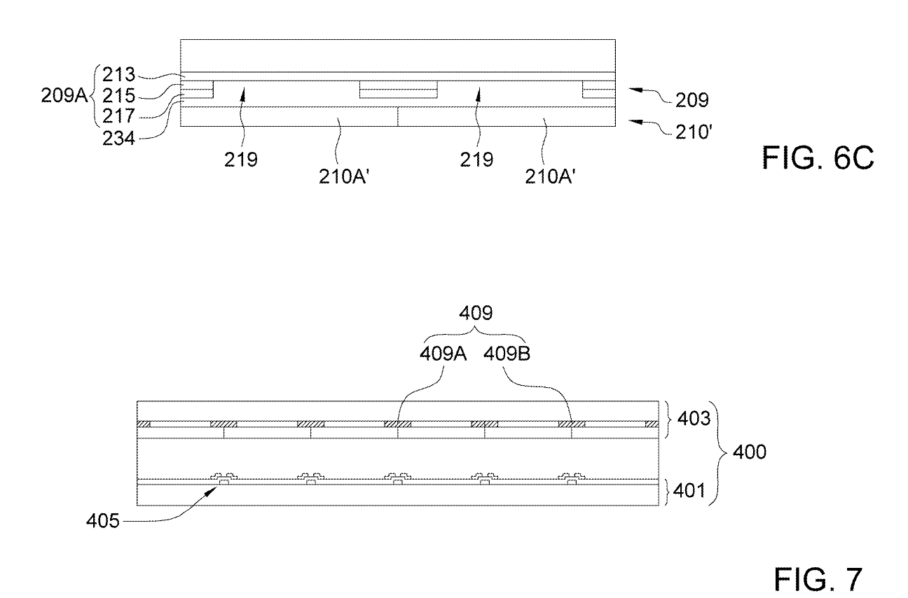

In the foregoing structures shown in FIG. 3B and FIG. 3C, the light filtering layer 210 directly fills up the first opening 219 and the second opening 229 of the black matrix 209. However, the invention is not limited thereto. Referring to FIGS. 6A, 6B and 6C, cross-sectional views of the second substrate of FIG. 2 viewed along the cross-sectional lines A-A′, B-B′, C-C′ with an insulation layer are respectively shown. The insulation layer 234 is disposed between the color filtering structure 210′ and the black matrix 209 as shown in FIG. 6B or FIG. 6C. The insulation layer 234 fills up the first opening 219 and the second opening 229 of the black matrix 209, and is entirely laid on the lower surface of the black matrix 209 as a protection layer or a flat layer. For example, the protection layer or a flat layer protects and avoids the first metal electrode 217 and the second metal electrode 227 being damaged in subsequent manufacturing processes. Besides, after the insulation layer 234 fills up the first opening 219 and the second opening 229, the lower surface of the black matrix 209 is leveled, lest the thickness of the color filtering structure 210′ might be uneven if the lower surface of the black matrix 209 is not even enough during the subsequent process of manufacturing the color filtering structure 210′.

Furthermore, in the above structure, the electronic device 1 radiates the display panel 200 with the backlight provided by the light source 100 so as to display images. However, the invention is not limited thereto. Referring to FIG. 7, a self-illuminant display element is shown. The self-illuminant display element 400, such as an organic light emitting diode (OLED) display element, includes a first substrate 401 and a second substrate 403, wherein, a plurality of pixel switch 405 is disposed on the first substrate 401. The second substrate 403 has a black matrix 409, which, like the design of the foregoing black matrix 209 or 209′, has at least one first photoelectric transform block 409A and one second photoelectric transform block 409B, therefore the black matrix 409 has photoelectric transform effect. The display pixel of the self-illuminant display element 400 provides the self-illuminant effect by the new power generated by the black matrix 409, hence saving the use of an external light source and simplifying the structure of the electronic device.

According to the photoelectric display panel and the electronic device using the same disclosed in the embodiments of the invention, on the part of a substrate, a structure with the property of photoelectric transformation is used as the black matrix of the color filtering structure, so that the substrate under the radiation of the light can generate photoelectric transform effect, and further generate current for charging or other purposes. Besides, the black matrix performs photoelectric transformation by an external light source and a light source of the electronic device at the same time, so that the generation of current is more effective. Currently, most display panels are driven by an external power. Particularly, the panel of an electronic device using a liquid crystal display panel is more power consuming, and the light source or other electronic elements inside the electronic device also need to be driven by a power. The display panel of the embodiments of the invention can supply the power by itself, and the power supply ability of the display panel is even enhanced in a place where the light is sufficient, so that the power will not be over consumed and the duration of the battery of the electronic device is prolonged.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A photoelectric display panel for being disposed in an electronic device, wherein the photoelectric display panel comprises:
a first substrate having a pixel array, wherein, the pixel array comprises a plurality of display pixels; and
a second substrate parallel to the first substrate, wherein the second substrate comprises a base plate and a black matrix located between the base plate and the first substrate, wherein the black matrix comprises:
a first photoelectric transform block having a first transparent electrode, a first semiconductor layer and a first metal electrode that are sequentially laminated on the base plate; and
a second photoelectric transform block having a second transparent electrode, a second semiconductor layer and a second metal electrode that are sequentially laminated on the base plate, wherein, the second transparent electrode is electrically connected with the first metal electrode, so that the second photoelectric transform block and the first photoelectric transform block are connected in series.

2. The display panel according to claim 1, wherein there is a first gap formed between the first transparent electrode and the second transparent electrode, the first semiconductor layer fills up the first gap and is partly extended to be on the second transparent electrode, there is a second gap formed between the first semiconductor layer and the second semiconductor layer, and the first metal electrode fills up the second gap for electrically connecting the second transparent electrode.

3. The display panel according to claim 1, wherein the first metal electrode and the second metal electrode respectively are a transparent metal film.

4. The display panel according to claim 1, wherein the first metal electrode and the second metal electrode respectively has a plurality of openings.

5. The display panel according to claim 4, wherein the first photoelectric transform block further has a third transparent electrode disposed between the first semiconductor layer and the first metal electrode, and the second photoelectric transform block further has a fourth transparent electrode disposed between the second semiconductor layer and the second metal electrode.

6. The display panel according to claim 1, wherein the second substrate further comprises a color filtering structure, the black matrix and the color filtering structure are sequentially located on the base plate and between the base plate and the first substrate, and the color filtering structure comprises a plurality of light filtering layers corresponding to the display pixels.

7. The display panel according to claim 6, wherein the second substrate further comprises an insulation layer disposed between the color filtering structure and the base plate.

8. The display panel according to claim 1, wherein the first semiconductor layer and the second semiconductor layer respectively are a P-N joint structure.

9. The display panel according to claim 8, wherein the P-N joint structure is amorphous Si, poly crystalline Si or micro-crystal Si.

10. The display panel according to claim 8, wherein the P-N joint structure is made from an organic semiconductor material or an inorganic semiconductor material.

11. The display panel according to claim 1, wherein the display pixels are self-illuminant display pixels.

12. An electronic device, comprising:
a light source; and
a display panel, wherein the display panel comprises:
a first substrate having a pixel array comprising a plurality of display pixels; and
a second substrate parallel to the first substrate, wherein the second substrate is disposed on the other side opposite to the light source, the second substrate comprises a base plate, a black matrix and a color filtering structure, the black matrix and the color filtering structure are sequentially located on the base plate and located between the base plate and the first substrate, the color filtering structure comprises a plurality of light filtering layers corresponding to the display pixels, and the black matrix comprises:
a first photoelectric transform block having a first transparent electrode, a first semiconductor layer and a first metal electrode sequentially laminated on the base plate; and
a second photoelectric transform block having a second transparent electrode, a second semiconductor layer and a second metal electrode sequentially laminated on the base plate, wherein, the second transparent electrode is electrically connected with the first metal electrode, so that the second photoelectric transform block and the first photoelectric transform block are connected in series.

13. The electronic device according to claim 12, wherein there is a first gap formed between the first transparent electrode and the second transparent electrode, the first semiconductor layer fills up the first gap and is partly extended to be on the second transparent electrode, there is a second gap formed between the first semiconductor layer and the second semiconductor layer, and the first metal electrode fills up the second gap for electrically connecting the second transparent electrode.

14. The electronic device according to claim 12, wherein the first metal electrode and the second metal electrode respectively has a plurality of openings.

15. The electronic device according to claim 14, wherein the first photoelectric transform block further has a third transparent electrode disposed between the first semiconductor layer and the first metal electrode, and the second photoelectric transform block further has a fourth transparent electrode disposed between the second semiconductor layer and the second metal electrode.

16. The electronic device according to claim 12, wherein the second substrate further comprises an insulation layer disposed between the color filtering structure and the base plate.
